(19) United States
(12) Patent Application Publication
(10) Pub. No.: US 2007/0036899 A1
(43) Pub. Date: Feb. 15, 2007

(54) Water resistant hydrophilic coatings

(75) Inventors: Damodar R. Patil, Peoria, IL (US); George F. Fanta, Morton, IL (US); Frederick C. Felker, Morton, IL (US)

Correspondence Address: CONLEY ROSE, P.C., P. O. BOX 3267, HOUSTON, TX, 77253-3267, US

(73) Assignee: Biotechnology Research and Development Corp., Peoria, IL (US)

(21) Appl. No.: 11/202,794

(22) Filed: Aug. 12, 2005

(51) Int. Cl. B05D 3/02; B05D 7/00; C08F 290/14

(52) U.S. Cl. 427/372.2; 427/421.1; 525/50; 525/56

(57) ABSTRACT

A water-resistant hydrophilic coating composition comprising a hydrophilic base material, an adhesion promoter, a surfactant and a crosslinking agent. A method of applying a water-resistant hydrophilic coating to a hydrophobic surface comprising; preparing the water-resistant hydrophilic coating, spraying the water-resistant hydrophilic coating on the hydrophobic surface and heating the coated surface. A method of water-proofing a polysaccharide coating comprising crosslinking the starch hydroxyl functionalities.

### CROSS-REFERENCE TO RELATED APPLICATIONS

This application is related to commonly owned U.S. patent application Ser. No. 11/138,787, filed on May 26, 2005 and entitled “Polysaccharide Based Hydrophilic Coatings,” which is incorporated by reference herein.

### STATEMENT REGARDING FEDERALLY SPONSORED RESEARCH OR DEVELOPMENT

Not applicable.

### BACKGROUND OF THE INVENTION

1. Field of the Invention

This invention relates generally to adhesive coatings. More specifically, this invention relates to water-resistant hydrophilic adhesive coatings for hydrophobic substrates.

2. Background of the Invention

Articles constructed from synthetic polymeric materials such as polyethylene (PE) and polypropylene (PP) have found widespread use in our daily lives. While such polymeric materials have desirable bulk mechanical properties they often exhibit undesirable surface properties. This may limit their utility since the surface properties of polymeric materials are often a major determinant in their usage. Thus, despite their widespread applications, a need exists to remedy certain limitations associated with the usage of synthetic polymeric materials. One method of increasing the adaptability of these polymeric materials to new uses has been to modify their surface properties. In particular, modifications of the surface of hydrophobic polymeric materials are often required to extend their utility.

One approach to surface modification involves altering the hydrophobicity of the polymeric surface by applying a coating having the desired properties. Introduction of a hydrophilic coating to the hydrophobic surface of a polymer material would make these materials suitable for applications that require biocompatibility, compatibility with hydrophilic reagents, reduced electrostatic charge, reduced friction, improved barrier properties and improved absorption of water-based dyes and inks. The application of a hydrophilic coating to a hydrophobic surface may also present some drawbacks. The hydrophilic coating is wettable and in some instances, such coatings when subjected to water for extended time periods and rubbed may no longer adhere to the substrate surface. Furthermore, there are many applications for which the water-resistant nature of a hydrophilic surface is desirable.

Thus it would be desirable to develop a hydrophilic coating for hydrophobic substrates that is water resistant.

### BRIEF SUMMARY OF SOME OF THE PREFERRED EMBODIMENTS

In an embodiment, a water-resistant hydrophilic coating composition is disclosed comprising a hydrophilic base material, an adhesion promoter, a surfactant and a crosslinking agent.

In an embodiment, a method of applying the water-resistant hydrophilic coating is disclosed comprising preparing a water-resistant hydrophilic coating, spraying the water-resistant hydrophilic coating on the hydrophobic surface and heating the coated surface.

In an embodiment, a method of water-proofing a polysaccharide coating is disclosed comprising crosslinking the starch hydroxyl functionalities.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a schematic of a pneumatic coating sprayer.

### DETAILED DESCRIPTION OF THE PREFERRED EMBODIMENTS

In an embodiment, a hydrophilic coating (HC) comprises a hydrophilic base material, an adhesion promoter, a surfactant and a crosslinking agent. The hydrophilic base material may be a water-soluble polymer. Without limitation, examples of water-soluble polymers include natural gums such as karaya, tragacanth, ghatti and guar gum; polyvinyl alcohol; polyvinyl pyrrolidone; modified celluloses such as carboxymethyl, hydroxyethyl or hydroxypropyl cellulose; polyacrylic acid; polyethylenimine; or combinations thereof. Alternatively, the water-soluble polymer is a starch, modified starch or starch mixture.

In an embodiment, the starch may be a non-gelling starch, a waxy starch, an amylose-containing starch or combinations thereof. As used herein, a non-gelling starch is one that does not form a viscous semi-rigid structure upon absorption of water and heating or during the cooling of said solution. As used herein a waxy starch is one that contains less than about 10% weight/weight (w/w) amylose. As used herein an amylose-containing starch is one having equal to or greater than about 10% amylose. In an embodiment, the amylose content of the starch is less than about 13%, alternatively less than about 12%. Without wishing to be limited by theory, the reduced amylose content in the HC may prevent retrogradation and gel formation thereof.

In some embodiments, the starch is a gelling starch wherein gel formation can be reversed or inhibited. For example, the starch may be an amylose-containing starch containing greater than or equal to about 25% amylose. Starch containing greater than or equal to about 25% amylose when dissolved in water and heated forms a gel when the solution is allowed to cool at room temperature. However, agitating the cooled solution, for example by stirring or shaking, may reverse the gel formation. Alternatively, gel formation in a 25% amylose containing starch solution may be inhibited by rapidly cooling the solution. Methods of rapidly cooling a solution are known to one skilled in the art and include for example transfer of the hot solution to an ice bath.

Starches suitable for use in the HC include without limitation those isolated from cereal crops such as rice and corn or tuber crops such as cassaya and potato. Without limitation, examples of suitable starches include Starch from Rice (S7260) and/or Starch from Corn (S9679) both available from Sigma, Aldrich and Pure Food Grade starch and/or 7350 Waxy starch #1 both available from A. E. Staley. In an embodiment, the HC comprises from about 2% w/v to about 8% w/v starch, alternatively from about 4% w/v to about 6% w/v starch. The w/v is defined as the number of grams of a component in a solution divided by the total volume in milliliters of the solution multiplied by 100%. Herein, the term aqueous solution also refers to aqueous dispersions, in which solid materials are intimately dispersed in water so that they do not readily settle or otherwise separate from the aqueous phase. In an embodiment, aqueous solutions of each reagent in the HC are prepared by dissolving the reagent in a suitable volume of water. The concentration of the reagents at this point is termed the initial % w/v. The initial % w/v is calculated by dividing the grams of reagent used by the volume in milliliters of solution (e.g., water) added to produce the aqueous solution. In an embodiment, these aqueous solutions of reagents are used to prepare the HC. For convenience, the HC formulations are based on 100 grams of HC, with a resultant calculation of the grams of aqueous reagent required to prepare the 100 grams of HC. Upon addition of each of the reagents to the HC, the concentration of the reagent is diluted from the initial % w/v to a final % w/v. The final % w/v of each reagent in the HC is determined by multiplying the initial % w/v of each component by the number of grams of component used in preparing the 100 grams of the HC. The sum of the % w/v contribution of each component in the HC is referred to herein as the total solids content. Hereafter, the numerical values given with percentages refer to the final % w/v unless noted otherwise.

In an embodiment, the starch is provided as an aqueous starch solution. This aqueous starch solution may contain a sufficient amount of starch and water to produce an HC with a viscosity suitable for ease of pouring and/or sprayability. In an embodiment, the starch slurry may comprise an initial % w/v of from about 10% to about 20% starch in aqueous solution having a pH of from about 5 to about 7, alternatively about 7.

In some embodiments, the water-soluble polymer may be substituted with a water-dispersible or water-reducible polymer to provide a final formulation that is less hydrophilic in nature than the HC formed with a water-soluble polymer. Examples of water-dispersible and water-reducible polymers are known to one skilled in the art. HCs formed using water-dispersible or water-reducible polymers as the hydrophilic base material may result in coatings that are less hydrophilic than those formulated using water-soluble polymers as the hydrophilic base material. However, when compared with the surface of a suitable hydrophobic polymeric substrate, the HCs prepared with water-reducible or water-dispersible polymers may be more hydrophilic than the substrate surface. Thus, application of an HC having a water-dispersible polymer or water-reducible polymer as the hydrophilic base material may provide a coating that enhances desirable surface properties of the substrate to which it is applied. However, for simplicity herein the term HC refers collectively to coatings prepared with water-dispersible, water-reducible or water-soluble polymers.

In an embodiment, the HC comprises an adhesion promoter. Without wishing to be limited by theory, the adhesion promoter may serve to increase the compatibility between the HC and the hydrophobic substrate through the reduction of interfacial tension. Interfacial tension is defined as the surface free energy that exists between two immiscible liquid phases, such as oil and water. In an embodiment, the adhesion promoter is any material chemically compatible with the HC that serves to increase the adherence of the HC to the hydrophobic substrate by reducing the interfacial tension. In an embodiment, the adhesion promoter is an epoxy resin present in amounts of from about 0.5% to about 2.0% of the HC.

Without limitation, examples of suitable adhesion promoters include EPI-REZ Resin 3510-W-60 available from Resolution Performance Products and Epoxy 6128W65 from Pacific Epoxy Polymers. In an embodiment, an adhesion promoter for use in the HC (e.g., EPI-REZ Resin 3510-W-60) has about the physical properties given in Table I.

TABLE I

| Physical Property | Value |
|---|---|
| Viscosity at 25° C. | 500-5000 |
| (Brookfield RVT, #5 spindle at 10 rpm) | |
| Nonvolatiles, percent | 60-62 |
| Solvent | Water |
| Pounds/gallon | 9.0 |
| Particle size, Coulter (vol. mean), microns | 1.0-2.2 |
| pH | 2-5 |
| Weight per epoxide, on solids | 185-215 |

In an embodiment, the HC comprises a surfactant. Without wishing to be limited by theory, a surfactant in the HC may serve to modify physical properties thereof such as the surface tension, emulsification or cloud point. The surface tension is defined as the free energy between a liquid and air. In an embodiment, the surfactant is any material chemically compatible with the HC that is capable of reducing the surface tension of the HC while increasing adhesion of the HC to the substrate. In an embodiment, the surfactant is a fluorosurfactant. In an alternative embodiment, the surfactant is sodium lauryl sulfate. In an embodiment the HC comprises from about 0.05% to about 0.5% of surfactant, alternatively from about 0.1% to 0.3% of surfactant, alternatively about 0.25% surfactant. Without limitation, examples of suitable surfactants include ZONYL FSA and ZONYL FSP available from Dupont and sodium lauryl sulfate available from Sigma-Aldrich. In an embodiment, a surfactant for use in the HC (e.g., ZONYL FSP) has about the physical properties given in Table II.

TABLE II

| Property | Value |
|---|---|
| Structure | (R_{f}CH₂CH₂O)xP(O)(ONH₄)y |
| | where R_{f} = F(CF₂CF₂)z |
| | x = 1 or 2 |
| | y = 2 or 1 |
| | x + y = 3 |
| | z = 1 to about 7 |
| Solubility | [symbol] 2% in water and methyl alcohol |
| | 0.7% in isopropyl alcohol |
| | 0.1% in acetone |
| | insoluble in ethyl acetate, THC, |
| | n-heptane, methyl chloroform and |
| | toluene |
| Specific gravity @ 25° C. | 1.15 |
| Density @ 25° C. (lb/gal) | 9.6 |
| Surface tension in deionized | 24 @ 0.01% active ingredient |
| water @ 25° C. (dyn/cm) | |

In an embodiment, the HC comprises a crosslinking agent. Without wishing to be limited by theory, a crosslinking agent in the HC may serve to render the HC water-resistant through a reaction of the starch hydroxyl groups with a functionality of the crosslinking agent. Such reactions would make the starch hydroxyl groups unable to hydrogen bond with water thus resulting in a water-resistant coating. The addition of a crosslinking agent to the HC may also increase the resistance of the starch to swelling and gelatinization. In an embodiment, the crosslinking agent is a melamine resin, alternatively a methylated melamine resin, alternatively a methylated melamine formaldehyde resin, alternatively a methylated high imino melamine resin, alternatively a derivative of hexamethoxymethylmelamine (HMMM) or combinations thereof. In an embodiment, the HC comprises from about 0.5% to about 4% cross-linking agent, alternatively from about 1% to about 3% cross-linking agent, alternatively about 2% cross-linking agent. Without limitation, a representative example of a suitable crosslinking agent is a methylated high imino melamine resin sold as CYMEL 323 by Cytec Industries Inc. In an embodiment, a crosslinking agent for use in the HC (e.g., CYMEL 323) has about the physical properties given in Table III.

TABLE III

| Property | Value |
|---|---|
| Non-Volatile % 45° C. for 45′ | 78-82 |
| M/F/Me approx.¹ | 1/3.8/2.8 |
| Monomer Content Approx.² | 58 |
| Viscosity mPa s 23° C. | 2500-7500 |
| Density lbs/gal (kg/M³) approx. | 9.3 (1120) |
| Flashpoint ° C. | 33 |

¹M/F/Me refers to the ratio of metholyated melamine to formaldehyde to melamine in the crosslinking agent.
²The crosslinking agent forms multimers in solution. This value is the approximate amount of HMMM monomer present in solution.

The HC may optionally comprise a crosslinking agent accelerator (CAA). Such a compound may serve to reduce the reaction time of the crosslinking agent and accelerate the formation of a water-resistant HC. In an embodiment, the CAA is any agent chemically compatible with the HC and that is able to accelerate the reaction of the crosslinking agent and hydrophilic base material. In an embodiment, the CAA is a polymer, alternatively an anionic polymer, alternatively a carboxyl-containing polymer, alternatively a carboxylated styrene-butadiene latex or combinations thereof. In an embodiment, the HC comprises from about 2% to about 4% CAA. Without limitation, a representative example of a suitable CAA is a carboxylated styrene-butadiene latex sold as ROVENE 4009 by Mallard Creek Polymers Inc. In an embodiment, the CAA (e.g., ROVENE 4009) has about the physical properties given in Table IV.

TABLE IV

| Properties | Value |
|---|---|
| % Solids | 54 |
| Viscosity (cps) ¹ | 300 |
| pH | 7.25 |
| Particle size (nm) | 200 |
| Tg (° C.) ² | −4 |
| Styrene/Butadiene ratio | 58/42 |

¹ cps = centipoises
² Tg is the glass transition temperature

The HC may further comprise an effective amount of additives for improving or changing the properties thereof, including without limitation emulsifiers, plasticizers or combinations thereof. In an embodiment, the HC contains a plasticizer, which may serve to increase the flexibility, durability and shelf life thereof. Alternatively, the HC contains an emulsifier that may prevent separation of the formulation components. Suitable plasticizers and emulsifiers are known to one of ordinary skill in the art. In an embodiment, the HC may contain a single compound that functions as both a plasticizer and an emulsifier. Without limitation, an example of a plasticizer that also functions as an emulsifier for use in the HC is a nonionic/anionic wax emulsion sold as AQUABEAD 270E by Micro Powders Inc.

Other additives chemically compatible with the formulation may be introduced by one skilled in the art to vary the properties of the HC as needed. By way of example, the HC may be varied to contain antimicrobial agents or dyes if necessary to impart certain physical properties to the hydrophobic substrate.

In an embodiment, the HC may comprise from about 4% to about 6% hydrophilic base material, from about 0.5% to about 2% adhesion promoter, from about 0.1% to about 0.25% surfactant, from about 1% to about 4% crosslinking agent, from about 2% to about 4% CAA and optionally an effective amount of any additional additives with the remainder of the HC being an aqueous carrier fluid, such as water. In an embodiment, the HC may have a total solids content from about 6% to about 18%, alternatively from about 6% to about 15%, alternatively from about 6% to about 10%. In an embodiment, the HC has a viscosity from about 80 centipoise to about 300 centipoise (cp), alternatively from about 100 cp to about 250 cp, alternatively less than about 200 cp.

In an embodiment, for preparation of the HC, the hydrophilic base material is heated prior to the addition of other reagents. In an embodiment, the hydrophilic base material is a starch that is provided as a starch slurry. The starch slurry may be heated by any method suitable for heating and maintaining the temperature of the starch slurry. Without wishing to be limited by theory, heating the starch slurry may make the starch completely water-soluble by disrupting the starch granules and breaking the hydrogen bonding. The starch slurry may be heated by the process of jet-cooking. Herein the process of “jet cooking” refers to using a heat transfer device to instantaneously heat a flowing liquid with a hot condensable vapor and hold the heated liquid at a prescribed temperature for a prescribed time. Processes for jet cooking a starch slurry have been disclosed in U.S. Pat. Nos. 3,988,483, 4,232,046 and 6,709,763, each of which are incorporated by reference herein in their entirety. Examples of heat transfer devices suitable for use in jet cooking an aqueous starch slurry are the HYDROHEATER available from Attec and the AWEC 2400 mixing jet cooker available from Q-Jet DSI Inc.

Suitable conditions for jet cooking a starch slurry are known to one skilled in the art. The starch slurry may be jet cooked at a temperature from about 130° C. to about 150° C. and a pressure from about 20 psig to about 50 psig with a pumping rate of from about 0.75 to about 2.0 liters per minute. In an embodiment, the jet-cooked aqueous starch slurry is rapidly cooled by placing the slurry on ice. In another embodiment, the jet-cooked aqueous starch slurry is cooled to room temperature and a starch gel forms. The starch gel may then be redispersed in solution by mechanical agitation such as stirring or shaking. In yet another embodiment, the jet-cooked aqueous starch slurry is removed from the heat source and allowed to cool to room temperature.

After treating the hydrophilic base material (e.g., starch slurry) as described, an appropriate amount of heated hydrophilic base material, adhesion promoter, surfactant, crosslinking agent, CAA, additives and water may be mixed together to prepare the HC. In some embodiments, the HC may be transferred to a device for application of the coating to a substrate. Alternatively, a single device may be used to prepare the HC and coat the substrate. The HC may be sprayed onto a hydrophobic surface. Sprayers suitable for use in this application are known to one skilled in the art and include pneumatic sprayers or spray guns. Examples of suitable pneumatic sprayers include without limitation, the EGA Manual Touch-Up Gun available from DeVilbiss Corporation or the AJ-401-LH sprayer available from Jacto.

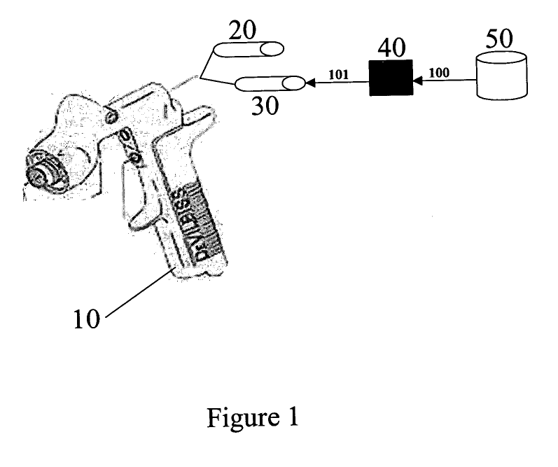

An embodiment of an apparatus for coating the hydrophobic substrate with the HC is depicted in FIG. 1. Referring to FIG. 1, a pneumatic sprayer 10 is coupled to container 20, reservoir 30, peristaltic pump 40 and solution container 50. Container 20 may contain a compressed gas such as air that is used to atomize the HC. In an embodiment, the HC is conveyed to reservoir 30 from solution container 50 by peristaltic pump 40 through lines 100 and 101. In an alternative embodiment, (not depicted), pneumatic sprayer 10 is fed by a local reservoir 30 coupled directly to the sprayer. In another alternative embodiment, (not depicted), the pneumatic sprayer 10 is directly coupled to line 101 and the contents of solution container 50 are fed directly to pneumatic sprayer 10 by peristaltic pump 40 through lines 100 and 101. Alternatively, any device suitable for storing and/or transferring the HC to the pneumatic sprayer 10 may be employed. Alternatively, the HC may be manually transferred to the pneumatic sprayer 10.

In an embodiment, the HC may be heated during application of the HC to the substrate, following application of the HC to the substrate or both during and following application of the HC to the substrate. The coated substrate may be heated at any temperature and for any time period using any known heating device that is compatible with both the coating and the substrate and activates the crosslinking agent. Herein the term activating the crosslinking agent refers to facilitating the reaction of the crosslinking agent and hydrophilic base material. Alternatively, the coated substrate may be heated in an oven at a temperature of equal to or greater than about 80° C. for from about 12 to about 24 hours, alternatively from about 12 hours to greater than about 24 hours. In some embodiments, the heating of the HC coated substrate is carried out under vacuum. Process conditions such as time, temperature, pressure and combinations thereof may be adjusted to achieve a desired level of crosslinking and resultant performance of the HC. Such process conditions may also vary based on the HC composition, for example based on the presence and amount of a CAA.

The HC may form a monolayer adhesive coating on the substrate. Alternatively, the substrate may be coated repeatedly with the HC to form a multilayer adhesive coating comprising from about 1 to about 24 layers. Hereafter, the term starch adhesive coating (SAC) refers to an HC comprising a starch as the hydrophilic base material, an adhesion promoter, a surfactant and a crosslinking agent that has been applied to a substrate in one or more layers but has not been heated to activate the crosslinker. Hereafter, the term water-resistant starch adhesive coating (WRSAC) refers to an HC comprising a starch as the hydrophilic base material, an adhesion promoter, a surfactant and a crosslinking agent that has been applied to a substrate in one or more layers and has been heated to activate the crosslinker. Herein a water-resistant coating refers to a coating whose adhesion after exposure to water for some time period is equivalent to its adhesion prior to water exposure, where adhesion is determined in accordance with ASTM D 3359-02. Alternatively, a water-resistant coating is a coating that passes the Rub Test. Herein the Rub test refers to a procedure wherein the putative WRSAC is exposed to water for some period and then subjected to manual rubbing. The WRSAC is considered to have passed the Rub Test and is therefore characterized as water resistant if it continues to adhere to the substrate surface after this process.

The HC containing a crosslinking agent may be used to coat a suitable substrate thus providing a water-resistant hydrophilic layer to a surface. Suitable substrates for the HC include but are not limited to hydrophobic surfaces, alternatively polymeric surfaces, alternatively polyolefin surfaces. The substrate may comprise a homopolymer, copolymer, or blends thereof. Examples of suitable material surfaces that may serve as substrates for the HC include without limitation polyethylene terepthalate; polyethylenes such as high-density polyethylene, low-density polyethylene, linear low-density polyethylene; polypropylene; polyvinyl chloride; polystyrene and combinations thereof.

Polymer resins having the previously described properties may be formed into articles of manufacture or end use articles using techniques known in the art such as extrusion, blow molding, injection molding, fiber spinning, thermoforming, and casting. For example, a polymer resin may be extruded into a sheet, which is then thermoformed into an end use article such as a container, a cup, a tray, a pallet, a toy, or a component of another product. Examples of other end use articles into which the polymer resins may be formed include pipes, films, bottles, fibers, and so forth. In an embodiment, the substrate is an article of packaging of a consumer product. Additional end use articles would be apparent to those skilled in the art. The surface of such articles may serve as substrates for the HC.

In an embodiment, the HC produces a SAC or WRSAC capable of adhering to a hydrophobic substrate with an adhesion strength of from about 3 to about 5, alternatively from about 4 to about 5 as determined in accordance with ASTM D 3359-02, the standard method for measuring adhesion by tape test. In an embodiment, the SAC formed upon application of the HC to the substrate has an adhesion that is increased by heating the HC and substrate to activate the crosslinking agent and form a WRSAC. For example, the SAC prior to heating may have an adhesion of 4; however, following heating and the formation of a crosslinked material, the WRSAC may have an adhesion of 5. In an embodiment, the adhesion of the WRSAC is about 20% greater than that of the SAC having an identical composition. In an embodiment, the WRSAC adheres sufficiently to the substrate surface to resist separation from the surface of the substrate when the surface is manually and/or mechanically bent or flexed. In an embodiment, the WRSAC adheres sufficiently to the substrate surface to resist separation from the substrate surface when the WRSAC is manually rubbed, soaked in water or combinations thereof.

The WRSAC may form a uniform hydrophilic coating on the substrate surface with a monolayer thickness of less than about 2 to less than about 5 microns. A WRSAC formed by the methodology disclosed herein may have starch absorbed from about 0.01 to 0.2 mg per square cm of substrate, alternatively from about 0.035 to about 0.15 mg per square cm of substrate. A WRSAC of this disclosure may have an opaque (turbid) appearance.

Substrates having HCs of this disclosure may display desirable surface properties such as biocompatibility, compatibility with hydrophilic reagents, reduced electrostatic charge, and reduced friction and water resistance.

### EXAMPLES

The invention having been generally described, the following examples are given as particular embodiments of the invention and to demonstrate the practice and advantages thereof. It is to be understood that the examples are given by way of illustration and are not intended to limit the specification of the claims in any manner.

### Comparative Example 1

Starch slurries were prepared by jet cooking 700 g of waxy cornstarch in 3500 ml of water at 140° C. and 40 psig at a rate of 1 liter/minute in a Penick and Ford Laboratory Model Steam Jet Cooker. Referring to Table V, an HC was prepared by mixing the indicated amounts of reagents. Hereafter, the remainder of the formulation (i.e. the balance to total 100 grams) is water. The final starch concentration was 6% w/v. All percentages in the examples are of final % w/v unless otherwise indicated.

The HC was stirred for 30 minutes and the viscosity of the HC measured by a Brookfield Viscometer Model LV at 60 RPM. The HC was fed to a pneumatic sprayer (EGA Manual Touch-Up Gun), which was used to coat a 6″×6″ polyethylene surface. During application of the coating, a hot air gun set on the highest setting was aimed at the pneumatic sprayer in order to facilitate the HC drying upon contacting the plastic surface.

TABLE V
Formulation for Starch Adhesive coating

| Reagent* | Grams | %** |
|---|---|---|
| JCW Starch (13.1%) | 45.8 | 6.0 |
| AQUABEAD 270E (40%) | 3.0 | 1.2 |
| EPI-REZ Resin 3510-W-60 (62%) | 3.2 | 2.0 |
| ZONYL FSA (25%) | 1.0 | 0.25 |
| Water | 47 | balance |

*In parentheses is given the initial w/v of each reagent.
**% refers to the final % w/v in the HC.

In this and all subsequent examples, % refers to the final % w/v calculated as described herein while in parentheses next to each reagent is given the initial % w/v. The above HC had a total solids content of 9.45% and showed no settling of particles after being kept for 72 hours at 25° C. The total solids content was varied by adjusting the amount of starch slurry in the HC from 4% to 6%. The extent of adhesion for three HCs with the indicated total solids content were determined in accordance with ASTM D 3359-02, (the tape test method) and are given in Table VI.

TABLE VI
Effect of Total Solids Content on Adhesion

| Total Solids Content | Viscosity, cps | Adhesion |
|---|---|---|
| 9.45 | 140 | Almost 5A |
| 8.0 | 90 | Almost 5A |
| 6.0 | 55 | Almost 5A |

The results demonstrate that HCs having a total solids content in the range of 6% to 9.45% produced hydrophilic coatings with an adhesion of almost 5A. However, HCs containing greater than 6% starch concentration were highly viscous and formed hydrophilic coatings with no improvements or increases in adhesion above those observed at the 6% starch concentration. HCs with less than 4% starch concentration were too dilute for coating applications. Additionally, the hydrophilic coatings formed in this experiment were not water-resistant (i.e. they failed the Rub Test).

### Example 2

A HC was prepared as described in Comparative Example 1 with addition of the crosslinking agent CYMEL 323 to a final % w/v of 2. The formulation was used to coat a PE substrate as described in Example 1 and the coated substrate was further treated by oven heating at 80° C. in a vacuum oven for 24 hours to activate the crosslinking agent. The resultant WRSAC was hydrophilic, did not separate from the surface when the substrate was manually bent or flexed and did not separate from the surface of the substrate when the coatings were manually rubbed after being soaked in water for 30 min. Formulations were prepared containing different concentrations of the crosslinking agent, CYMEL 323, as indicated in Table VII.

TABLE VII
Effect of Melamine-Formaldehyde resin
and its concentration on cross-linking

| | Expt. | | | | | |
|---|---|---|---|---|---|---|
| | A | | B | | C | |
| | gms | % | gms | % | gms | % |
| Starch (12.7%) | 47.2 | 6.0 | 47.2 | 6.0 | 47.2 | 6.0 |
| Aqua 270 E (40%) | 3.0 | 1.2 | 3.0 | 1.2 | 3.0 | 1.2 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 44.35 | — | | — | | — |
| Total | 100 | | 100 | | 100 | |

| | | | |
|---|---|---|---|
| Viscosity, cp | 160 | 160 | 155 |
| Sprays/samples | 8 (3) | 8(4) | 8 (4) |
| Adhesion | 4A | 4A | 3A |
| WR/Adhesion | WR/5A | WR/5A | WR/5A |

The viscosity of the HC and the adhesion of the resultant SAC and WRSAC were determined as described in Example 1. In Table VII, the sprays/samples indicates the number of layers of HC applied to the substrate. The adhesion of the SAC (i.e., before heating) is given in the row labeled Adhesion and of the WRSAC (i.e. after heating) is given in the row labeled WR/Adhesion. These results demonstrate the addition of a crosslinking agent to the HC results in the formation of a WRSAC once the sample is heated to activate the crosslinking agent. Furthermore, the adhesion of the HC formulation increases to 5 with heating and the activation of the crosslinking agent.

TABLE VIIA
Effect on temperature of crosslinking

CYMEL conc. %

| | 1.0 | 2.0 | 4.0 | 1.0 | 2.0 | 4.0 |
|---|---|---|---|---|---|---|
| Expts. | A1 | B1 | C1 | A2 | B2 | C2 |
| Temp. ° C. | 60 | 60 | 60 | 80 | 80 | 80 |
| Cross-linking | no | no | no | yes | yes | yes |
| WR | no | no | no | yes | yes | yes |
| Adhesion | — | — | — | 5A | 5A | 5A |

The activation of the crosslinking agent in the HC occurred when the compositions were heated at temperatures above 60° C. for 24 hours. When samples having the same compositions given in Table VII were heated at 60° C. for 24 hours, the formation of a WRSAC was not observed, Table VIIA.

### Example 3

Starch slurries were prepared by jet-cooking amylose-containing starch once as described in Example 1. The hot starch dispersions obtained from jet-cooking amylose-containing starch were further divided into two fractions. One fraction (1^{st} fraction) was cooled at ambient temperature while the second fraction (2^{nd} fraction) was rapidly cooled by placing on ice. The 1^{st} fraction formed a gel upon cooling that could be redispersed by stirring or shaking while the 2^{nd} fraction remained fluid and no gel formation was observed. A second starch slurry was prepared by cooking the amylose-containing starch two times. This twice-cooked slurry was then divided into two fractions and treated as described previously. Each of these fractions of jet-cooked amylose-containing starch was used to prepare HCs containing 4% starch as the hydrophilic base material, the adhesion promoter 2% EPI-REZ Resin 3510-W-60, the combined plasticizer and emulsifier 0.8% AQUABEAD 270E, the fluorosurfactant 0.25% ZONYL FSA and the indicated amounts of crosslinking agent, CYMEL 323. The formulations were used to coat a polyethylene surface, as described in Example 2, and the viscosity of the HC and the adhesion of the resultant SAC and WRSAC were determined as described in Example 1. The compositions, amounts of each reagent, viscosity measurements and adhesion measurements are given in Tables VIIIA-VIIID.

TABLE VIIIA
Water resistant coatings from amylose containing
starch (Cooked once, ambient cooled: Fraction 1)

| | Expt. | | | | | |
|---|---|---|---|---|---|---|
| | A | | B | | C | |
| | gms | % | gms | % | gms | % |
| JC PFG Starch | 44.84 | 4.0 | 44.84 | 4.0 | 44.84 | 4.0 |
| (8.92%) | | | | | | |
| Aqua 270 E (40%) | 2.0 | 0.8 | 2.0 | 0.8 | 2.0 | 0.8 |
| Epi-rez 3510 (62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 47.71 | — | | — | | — |
| Total | 100 | | 100 | | 100 | |

| | | | |
|---|---|---|---|
| Viscosity, cp | 210 | 210 | 200 |
| Sprays/samples | 8(3) | 8(3) | 8(3) |
| Adhesion | 4A | 4A | 3A |
| WR/Adhesion | WR/5A | WR/5A | WR/5A |

TABLE VIIIB
Water resistant coatings from amylose containing
starch (Cooked once, rapidly cooled: Fraction 2)

| | Expt. | | | | | |
|---|---|---|---|---|---|---|
| | A | | B | | C | |
| | gms | % | gms | % | gms | % |
| JC PFG Starch | 44.84 | 4.0 | 44.84 | 4.0 | 44.84 | 4.0 |
| (8.92%) | | | | | | |
| Aqua 270 E (40%) | 2.0 | 0.8 | 2.0 | 0.8 | 2.0 | 0.8 |
| Epi-rez 3510 (62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 47.71 | — | | — | | — |
| Total | 100 | | 100 | | 100 | |

| | | | |
|---|---|---|---|
| Viscosity, cp | 125 | 125 | 125 |
| Sprays/samples | 8(3) | 8(3) | 8(3) |
| Adhesion | 4A | 4A | 3A |
| WR/Adhesion | WR/5A | WR/5A | WR/5A |

TABLE VIIIC
Water resistant coatings from amylose containing starch (Cooked
twice, ambient cooled: Fraction 1)

| | Expt. | | | | | |
|---|---|---|---|---|---|---|
| | A | | B | | C | |
| | gms | % | gms | % | gms | % |
| JC PEG Starch (8.25%) | 48.5 | 4.0 | 48.5 | 4.0 | 48.5 | 4.0 |
| Aqua 270 E (40%) | 2.0 | 0.8 | 3.0 | 0.8 | 2.0 | 0.8 |
| Epi-rez 3510 (62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | | — | | — | | — |
| Total | 100 | 100 | 100 | | | |

| | | | |
|---|---|---|---|
| Viscosity, cp | 140 | 140 | 140 |
| Sprays/samples | 8(3) | 8(3) | 8(3) |
| Adhesion | 4A | 4A | 3A |
| WR/Adhesion | WR/5A | WR/5A | WR/5A |

TABLE VIIID
Water resistant coatings from amylose containing
starch (Cooked twice, rapidly cooled: Fraction 2)

| | Expt. | | | | | |
|---|---|---|---|---|---|---|
| | A | | B | | C | |
| | gms | % | gms | % | gms | % |
| JC PFG Starch | 48.5 | 4.0 | 48.5 | 4.0 | 48.5 | 4.0 |
| (8.25%) | | | | | | |
| Aqua 270 E (40%) | 2.0 | 0.8 | 2.0 | 0.8 | 2.0 | 0.8 |
| Epi-rez 3510 (62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | | — | | — | | — |
| Total | 100 | | 100 | | 100 | |

| | | | |
|---|---|---|---|
| Viscosity, cp | 70 | 70 | 70 |
| Sprays/samples | 8(3) | 8(3) | 8(3) |
| Adhesion | 4A | 4A | 3A |
| WR/Adhesion | WR/5A | WR/5A | WR/5A |

All formulations using the amylose-containing starch formed a WRSAC whose adhesion increased from about 4 to an adhesion of 5 when the HC coated substrate was heated for 24 hours at 80° C. These results demonstrate the ability to form a WRSAC with a high-degree of adhesion using a traditionally gelling starch whose gel formation is inhibited by either rapidly cooling the starch or reversed by mechanical agitation.

### Example 4

Starch slurries were prepared as described in Example 1. An HC was prepared by adding 6% jet-cooked starch as the hydrophilic base material, the combined plasticizer and emulsifier 1.2% AQUABEAD 270E, the adhesion promoter 2% Epi-Rez Resin 3510-W-60, the fluorosurfactant 0.25% ZONYL FSA, water, the indicated amounts of crosslinking agent, CYMEL 323 and 2%-4% of the CAA ROVENE 4009 (Table IXA-IXC). HC coated substrates were prepared as previously described and heated for the indicated time periods at 80° C.

TABLE IXA
Effect of ROVENE 4009 (2% concentration)
on the cross-linking time

| | | Expt. | | | | | |
|---|---|---|---|---|---|---|---|
| | | A | | B | | C | |
| | | gms | % | gms | % | gms | % |
| 1 | JCW Starch | 47.2 | 6.0 | 47.2 | 6.0 | 47.2 | 6.0 |
| | (12.7%) | | | | | | |
| 2 | Aqua 270 E | 3.0 | 1.2 | 3.0 | 1.2 | 3.0 | 1.2 |
| | (40%) | | | | | | |
| 3 | Epi-rez 3510 | 3.2 | 2.0 | 3.2 | 2.0 | 3.2 | 2.0 |
| | (62%) | | | | | | |
| 4 | ZONYL FSA | 1.0 | 0.25 | 1.0 | 0.25 | 1.0 | 0.25 |
| | (25%) | | | | | | |
| 5 | ROVENE 4009 | 3.64 | 2.0 | 3.64 | 2.0 | 3.64 | 2.0 |
| | (55%) | | | | | | |
| 6 | CYMEL 323 | 1.25 | 1.0 | 2.5 | 2.0 | 5.8 | 4.65 |
| | (80%) | | | | | | |
| 7 | Water | 40.71 | — | | — | | |
| | Total | 100 | | 100 | | | |

| | | | |
|---|---|---|---|
| Viscosity, | 160 | 160 | 160 |
| cps | | | |
| Sprays | 8(3) | 8(3) | 8(3) |
| Adhesion | 4A | 4A | 3A |

| | Cross-linking by heat | | | | | | | | |
|---|---|---|---|---|---|---|---|---|---|
| | Above coated PE films were heated in oven | | | | | | | | |
| | to cross-link starch | | | | | | | | |
| | A1 | A2 | A3 | B1 | B2 | B3 | C1 | C2 | C3 |
| Time, h | 5 | 12 | 24 | 5 | 12 | 24 | 5 | 12 | 24 |
| Cross- | no | par- | yes | no | par- | yes | no | par- | yes |
| linking | | tial | | | tial | | | tial | |
| WR | no | | WR | no | | WR | no | | WR |
| WR/ | — | 4A | 4A | — | 4A | 4A | — | 4A | 4A |
| Adhesion | | | | | | | | | |

TABLE IXB
Effect of ROVENE 4009 (3% concentration)
on the cross-linking time

| | | Expt. | | | | | |
|---|---|---|---|---|---|---|---|
| | | A | | B | | C | |
| | | gms | % | gms | % | gms | % |
| 1 | JCW Starch | 47.2 | 6.0 | 47.2 | 6.0 | 47.2 | 6.0 |
| | (12.7%) | | | | | | |
| 2 | Aqua 270 E | 3.0 | 1.2 | 3.0 | 1.2 | 3.0 | 1.2 |
| | (40%) | | | | | | |
| 3 | Epi-rez 3510 | 3.2 | 2.0 | 3.2 | 2.0 | 3.2 | 2.0 |
| | (62%) | | | | | | |
| 4 | ZONYL FSA | 1.0 | 0.25 | 1.0 | 0.25 | 1.0 | 0.25 |
| | (25%) | | | | | | |
| 5 | ROVENE 4009 | 5.45 | 3.0 | 5.45 | 3.0 | 5.45 | 3.0 |
| | (55%) | | | | | | |
| 6 | CYMEL 323 | 1.25 | 1.0 | 2.5 | 2.0 | 5.0 | 4.0 |
| | (80%) | | | | | | |
| 7 | Water | 38.59 | — | | — | | |
| | Total | 100 | | 100 | | | |

| | | | |
|---|---|---|---|
| Viscosity, | 160 | 160 | 160 |
| cps | | | |
| Sprays | 8(3) | 8(3) | 8(3) |
| Adhesion - | 4A | 4A | 3A |
| ASTM | | | |

| | Cross-linking by heat: | | | | | | | | |
|---|---|---|---|---|---|---|---|---|---|
| | Above coated PE films were heated in oven | | | | | | | | |
| | to cross-link starch | | | | | | | | |
| | A1 | A2 | A3 | B1 | B2 | B3 | C1 | C2 | C3 |
| Time, h | 5 | 12 | 24 | 5 | 12 | 24 | 5 | 12 | 24 |
| Cross- | no | partial | yes | no | yes | yes | no | yes | yes |
| linking | | | | | | | | | |
| WR | no | | WR | no | WR | WR | no | WR | WR |
| Adhesion | — | 4A | 4A | — | 4A | 4A | — | 4A | 4A |

TABLE IXC
Effect of ROVENE 4009 (4% concentration)
on the cross-linking time

| | | Expt. | | | | | |
|---|---|---|---|---|---|---|---|
| | | A | | B | | C | |
| | | gms | % | gms | % | gms | % |
| 1 | JCW Starch | 47.2 | 6.0 | 47.2 | 6.0 | 47.2 | 6.0 |
| | (12.7%) | | | | | | |
| 2 | Aqua 270 E | 3.0 | 1.2 | 3.0 | 1.2 | 3.0 | 1.2 |
| | (40%) | | | | | | |
| 3 | Epi-rez 3510 | 3.2 | 2.0 | 3.2 | 2.0 | 3.2 | 2.0 |
| | (62%) | | | | | | |
| 4 | ZONYL FSA | 1.0 | 0.25 | 1.0 | 0.25 | 1.0 | 0.25 |
| | (25%) | | | | | | |
| 5 | ROVENE 4009 | 7.3 | 4.0 | 7.3 | 4.0 | 7.3 | 4.0 |
| | (55%) | | | | | | |
| 6 | CYMEL 323 | 1.25 | 1.0 | 2.5 | 2.0 | 5.0 | 4.0 |
| | (80%) | | | | | | |
| 7 | Water | 37.05 | — | | — | | |
| | Total | 100 | | 100 | | | 100 |

| | | | |
|---|---|---|---|
| Viscosity, | 160 | 160 | 160 |
| cps | | | |
| Sprays | 8(3) | 8(3) | 8(3) |
| Adhesion | 4A | 4A | 3A |

| | Cross-linking by heat | | | | | | | | |
|---|---|---|---|---|---|---|---|---|---|
| | Above coated PE films were heated in oven | | | | | | | | |
| | to cross-link starch | | | | | | | | |
| | A1 | A2 | A3 | B1 | B2 | B3 | C1 | C2 | C3 |
| Time, h | 5 | 12 | 24 | 5 | 12 | 24 | 5 | 12 | 24 |
| Cross- | no | partial | yes | no | yes | yes | no | yes | yes |
| linking | | | | | | | | | |
| WR | no | | WR | no | WR | WR | no | WR | WR |
| WR/ | — | 4A | 4A | — | 4A | 4A | — | 4A | 4A |
| Adhesion | | | | | | | | | |

The results demonstrate the formation of a WRSAC when the samples were heated for 12 hours in the presence of the CAA, ROVENE 4009. The addition of either 2% ROVENE 4009 (Table IXA), 3% ROVENE 4009 (Table IXB) or 4% ROVENE 4009 (Table IXC) decreased the reaction time of the crosslinking agent at 80° C. by approximately 50%.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A water-resistant hydrophilic coating comprising: a hydrophilic base material, an adhesion promoter, a surfactant and a crosslinking agent.

2. The composition of claim 1 wherein the hydrophilic base material is a water-soluble polymer, a water-dispersible polymer, a water-reducible polymer or combinations thereof.

3. The composition of claim 2 wherein the water-soluble polymer is a starch, a starch mixture, a modified starch, a gum, polyvinyl pyrrolidone, modified cellulose, polyvinyl alcohol, polyacrylic acid, polyethyleneimine or combinations thereof.

4. The composition of claim 3 wherein the starch, starch mixture or modified starch is nongelling.

5. The composition of claim 4 wherein the nongelling starch contains less than about 12% amylose.

6. The composition of claim 4 wherein the nongelling starch comprises from about 4% to about 6% of the total solids content of the hydrophilic coating.

7. The composition of claim 1 wherein the hydrophilic base material is a gelling starch.

8. The composition of claim 7 wherein the gelling starch is inhibited from gel formation by mechanical agitation or rapid cooling.

9. The composition of claim 1 wherein the adhesion promoter is an epoxy resin.

10. The composition of claim 1 wherein the surfactant is a fluorosurfactant, sodium lauryl sulfate or combinations thereof.

11. The composition of claim 1 wherein the crosslinking agent is a methylated melamine formaldehyde resin, a methylated high imino melamine resin, a derivative of hexamethoxymethylmelamine or combinations thereof.

12. The composition of claim 1 further comprising a plasticizer, an emulsifer or both.

13. The composition of claim 12 wherein the plasticizer, emulsifer or both comprises a nonionic/anionic wax emulsion.

14. The composition of claim 1 further comprising a crosslinking agent accelerator.

15. The composition of claim 14 wherein the crosslinking agent accelerator is a polymer, an anionic polymer, a carboxyl-containing polymer, a carboxylated styrene-butadiene latex or combinations thereof.

16. The composition of claim 1 having an adhesion of from about 4 to about 5 as determined in accordance with ASTM D 3359-02, the Tape Test Method.

17. The composition of claim 1 having a viscosity of from about 80 cps to about 300 cps.

18. A method of applying the water-resistant hydrophilic coating of claim 1 to a hydrophobic surface comprising preparing the water-resistant hydrophilic coating, spraying the water-resistant hydrophilic coating on the hydrophobic surface and heating the coated surface.

19. The method of claim 18 wherein the hydrophobic surface comprises a nonpolar homopolymer, copolymer, polymer blend or combinations thereof.

20. The method of claim 18 wherein the water-resistant hydrophilic composition is sprayed using a pneumatic spray device.

21. The method of claim 18 wherein the coated surface is heated at greater than or equal to about 80° C.

22. The method of claim 18 wherein the coated surface is heated under vacuum.

23. The method of claim 18 wherein the coated surface is heated for from about 12 hours to about 24 hours.

24. A method of water-proofing a polysaccharide coating comprising crosslinking the starch hydroxyl functionalities.

25. The method of claim 24 wherein waterproofing results in a coating that adheres to a surface following exposure to water and manual rubbing.
